(19) United States
(12) Patent Application Publication
(10) Pub. No.: US 2024/0034313 A1
(43) Pub. Date: Feb. 1, 2024

(54) DRIVER ASSISTANCE DEVICE

(71) Applicant: TOYOTA JIDOSHA KABUSHIKI KAISHA, Toyota-shi Aichi-ken (JP)

(72) Inventor: Koji MIYAI, Mishima-shi Shizuoka-ken (JP)

(73) Assignee: TOYOTA JIDOSHA KABUSHIKI KAISHA, Toyota-shi Aichi-ken (JP)

(21) Appl. No.: 18/359,388

(22) Filed: Jul. 26, 2023

(30) Foreign Application Priority Data
Jul. 28, 2022 (JP) 2022-120549

(51) Int. Cl. B60W 30/09; B60W 30/095; B60W 50/14; B60W 10/18; B60W 10/06; B60W 10/08; B60W 50/00

(52) U.S. Cl. CPC B60W 30/09; B60W 30/0956; B60W 50/14; B60W 10/18; B60W 10/06; B60W 10/08; B60W 50/0097; B60W 2420/42; B60W 2554/4045; B60W 2554/80; B60W 2552/53; B60W 2520/00; B60W 2050/146

(57) ABSTRACT

A driver assistance device according to the present disclosure includes a recognition sensor and a processor. The recognition sensor includes a camera that captures an image of another vehicle on a road having two or more lanes intersecting with a traveling lane of a subject vehicle, and is configured to recognize a situation around the subject vehicle. The processor is configured to execute a driver assistance process of assisting collision avoidance between the subject vehicle and the another vehicle. The processor is configured to predict whether or not the another vehicle performs a lane change from a farther lane to a closer lane when viewed from the subject vehicle, based on other-vehicle traveling information which is traveling information of the another vehicle detected by the recognition sensor. The processor is configured to execute the driver assistance process in a mode according to a result of the prediction.

### CROSS-REFERENCE TO RELATED APPLICATION

The present disclosure claims priority under 35 U.S.C. § 119 to Japanese Patent Application No. 2022-120549, filed on Jul. 28, 2022, which is incorporated herein by reference in its entirety.

### BACKGROUND

### Technical Field

The present disclosure relates to a driver assistance device applied to a vehicle.

### Background Art

JP 2019-191839 A discloses a driver assistance device. The driver assistance device calculates a moving locus of a moving body moving on a road intersecting with a traveling lane of a subject vehicle. Then, the driver assistance device determines whether or not there is a possibility that the moving object will collide with the subject vehicle by comparing the calculated moving locus with the moving locus of the subject vehicle.

### SUMMARY

When a road intersecting with the traveling lane of the subject vehicle has two or more lanes, another vehicle traveling on the road may perform a lane change from a farther lane to a closer lane when viewed from the subject vehicle. When the another vehicle performs the lane change as described above, it is desirable to appropriately perform driver assistance for avoiding a collision between the subject vehicle and the another vehicle.

The present disclosure has been made in view of the problem described above, and an object of the present disclosure is to provide a driver assistance device that can appropriately perform driver assistance for collision avoidance when another vehicle traveling on a road having two or more lanes intersecting with a traveling lane of a subject vehicle makes a lane change to a lane closer to the subject vehicle.

A driver assistance device according to the present disclosure includes a recognition sensor and a processor. The recognition sensor includes a camera that captures an image of another vehicle on a road having two or more lanes intersecting with a traveling lane of a subject vehicle, and is configured to recognize a situation around the subject vehicle. The processor is configured to execute a driver assistance process of assisting collision avoidance between the subject vehicle and the another vehicle. The processor is configured to predict whether or not the another vehicle performs a lane change from a farther lane to a closer lane when viewed from the subject vehicle, based on other-vehicle traveling information which is traveling information of the another vehicle detected by the recognition sensor. The processor is configured to execute the driver assistance process in a mode according to a result of the prediction.

The other-vehicle traveling information may include information indicating whether or not a turn signal of the another vehicle is blinking.

The other-vehicle traveling information may include information indicating a distance of the another vehicle to a lane division line closer to the subject vehicle among lane division lines that define a traveling lane of the another vehicle.

The subject vehicle may include one or more actuators configured to control at least one of driving and braking of the subject vehicle, and a human machine interface (HMI) device configured to perform notification to a driver of the subject vehicle. The result of the prediction may be a lane change probability that the another vehicle is predicted to perform the lane change. The driver assistance process may include a first process of controlling the one or more actuators to reduce forward movement of the subject vehicle, and a second process of controlling the HMI device to perform notification related to attention calling for the collision avoidance. The processor may be configured to execute the first process when the lane change probability is equal to or greater than a threshold value, and execute the second process when the lane change probability is less than the threshold value.

In a low vehicle speed condition in which a speed of the subject vehicle is equal to or lower than a designated speed, the processor is configured to execute the prediction and execute the driver assistance process in the mode according to the result of the prediction.

According to the driver assistance device of the present disclosure, the processor predicts whether or not another vehicle performs the above-described lane change, based on the other-vehicle traveling information detected by the recognition sensor. Then, the processor executes the driver assistance process for assisting collision avoidance between the subject vehicle and the another vehicle in a mode according to the result of the prediction. As a result, when another vehicle traveling on a road having two or more lanes intersecting with the traveling lane of the subject vehicle performs the lane change to a lane closer to the subject vehicle, the driver assistance for the collision avoidance can be appropriately performed.

### BRIEF DESCRIPTION OF THE DRAWINGS

FIG. 1 is a diagram schematically illustrating an example of a configuration of a vehicle including a driver assistance device according to an embodiment;

FIG. 2A is a diagram used to describe an outline of FCTA;

FIG. 2B is a diagram used to describe an issue on the FCTA;

FIG. 3 is a diagram illustrating an example of a scene in which a driver assistance process PR is executed based on a prediction of a lane change LC of another vehicle according to the embodiment; and

FIG. 4 is a flowchart related to the driver assistance process PR based on the prediction of the lane change LC of another vehicle according to the embodiment.

### DETAILED DESCRIPTION

Hereinafter, embodiments of the present disclosure will be described with reference to the accompanying drawings. In the drawings, common elements are denoted by the same reference numerals, and redundant description thereof will be omitted or simplified.

### 1. Configuration Example of Vehicle

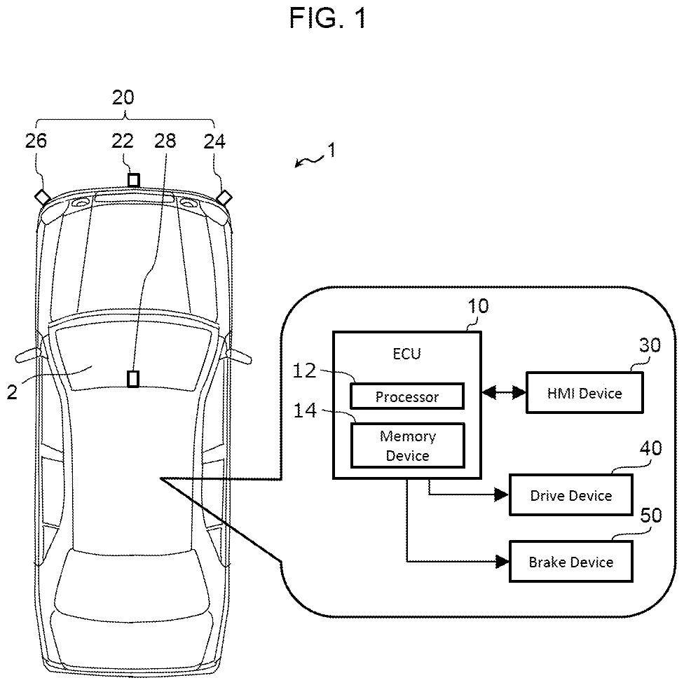

FIG. 1 is a diagram schematically illustrating an example of a configuration of a vehicle including a driver assistance device according to an embodiment. A vehicle 1 shown in FIG. 1 includes an electronic control unit (ECU) 10, a recognition sensor 20, a human machine interface (HMI) device 30, a drive device 40, and a brake device 50. It should be noted that the vehicle 1 may be an automated driving vehicle.

The ECU 10 is a computer configured to control the vehicles 1. The ECU 10 includes one or more processors (hereinafter, simply referred to as “processor”) 12 and one or more memory devices (hereinafter, simply referred to as “memory device”) 14. The processor 12 executes various processes related to the control of the vehicle 1. The memory device 14 stores various types of information necessary for the processes executed by the processor 12. The memory device 14 includes a volatile memory, a nonvolatile memory, a hard disk drive (HDD), and a solid state drive (SSD), for example. When the processor 12 executes various computer programs, various processes by the processor 12 are realized. The various computer programs are stored in the memory device 14 or recorded in a computer-readable recording medium. It should be noted that the ECU 10 may be configured by a plurality of ECUs.

The recognition sensor 20 is configured to recognize (detect) a situation around the vehicle (i.e., subject vehicle) 1. The recognition sensor 20 is electrically connected to the ECU 10. As an example, the recognition sensor 20 includes radars 22, 24, and 26 and a front camera 28. The radars 22, 24, and 26 are, for example, millimeter wave radars. The center front radar 22 detects an object present in a front area of the vehicle 1. The right front radar 24 detects an object present in a right front area of the vehicle 1. The left front radar 26 detects an object present in a left front area of the vehicle 1. The front camera 28 captures an image in front of the vehicle 1.

The HMI device 30 is configured to perform notification for calling attention to the driver of the vehicle 1. The HMI device 30 includes, for example, a display device for visually attracting attention. The display device is, for example, a display mounted on an instrument panel of the vehicle 1 or a head-up display (HUD) that displays information on a windshield 2 of the vehicle 1. In addition, the HMI device 30 includes, for example, at least one of a buzzer and a speaker for calling attention through hearing together with the display. The HMI device 30 is controlled by the ECU 10 (processor 12).

The drive device 40 generates a driving force of the vehicle 1. The drive device 40 includes, for example, at least one of an electric motor and an internal combustion engine for driving the vehicle 1. The brake device 50 generates a braking force of the vehicle 1. The brake device 50 includes a brake actuator for braking the vehicle 1. It should be noted that at least one of the electric motor and the internal combustion engine corresponds to an example of an “actuator” according to the present disclosure. Similarly, the brake actuator corresponds to another example of the “actuator” according to the present disclosure.

In the example of the vehicle 1 having the configuration described above, the “driver assistance device” according to the present disclosure includes the ECU 10 having the processor 12, the recognition sensor 20, and the HMI device 30.

### 2. Driver Assistance for Collision Avoidance

### 2-1. Issue on FCTA

FCTA (Front Cross Traffic Alert) is known as one of conventional techniques for assisting a driver of a subject vehicle in driving in order to avoid a collision with a moving object such as another vehicle. The FCTA is performed when designated operating conditions are met. The operating conditions include, for example, that the speed of the subject vehicle is equal to or lower than a designated speed (for example, 15 km/h).

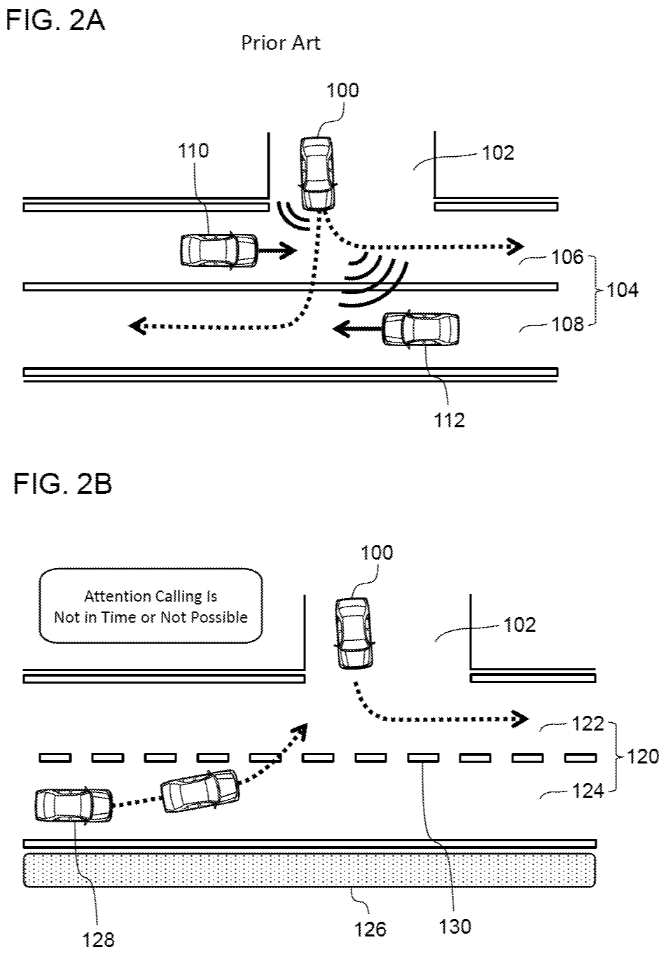

FIG. 2A is a diagram used to describe an outline of the FCTA. FIG. 2A illustrates a road 104 having one lane on each side and intersecting with a traveling lane 102 of the subject vehicle 100. The road 104 has an intersecting lane 106 and an intersecting lane 108. The intersecting lane 106 is located on a side closer to the traveling lane 102. The intersecting lane 108 is an opposite lane to the intersecting lane 106, and is located on a side farther from the traveling lane 102. In FIG. 2A, another vehicle 110 is traveling in the intersecting lane 106, and another vehicle 112, which is an oncoming vehicle of the another vehicle 110, is traveling in the intersecting lane 108.

In the FCTA, when the subject vehicle 100 is about to enter the intersecting lane 106 or 108, an ECU of the subject vehicle 100 detects the approach of the another vehicle 110 or 112 to the subject vehicle 100 by using a recognition sensor such as a radar. When detecting the approach, the ECU alerts the driver of the subject vehicle 100 about the approach. The attention calling is performed using an HMI device.

More specifically, FIG. 2A illustrates the subject vehicle 100 that is about to merge into the intersecting lane 106 or 108 while starting from a stopped state or traveling at a low speed on the traveling lane 102. According to the FCTA, if the another vehicle 110 is present when the subject vehicle 100 makes a left turn and is about to merge into the intersecting lane 106, the approach of the another vehicle 110 is detected, and an attention calling regarding the approach is performed. On the other hand, if the another vehicle 112 is present when the subject vehicle 100 makes a right turn and is about to merge into the intersecting lane 108, the approach of the another vehicle 112 is detected, and an attention calling regarding the approach is performed.

FIG. 2B is a diagram used to describe an issue on the FCTA. FIG. 2B illustrates a road 120 having two lanes on each side and intersecting with the traveling lane 102 of the subject vehicle 100. The road 120 is, for example, an arterial road and includes two intersecting lanes 122 and 124 and a central separation zone 126. The intersecting lane 122 is located on a side closer to the traveling lane 102. The intersecting lane 124 is located on a side farther from the traveling lane 102 and is adjacent to the intersecting lane 122. The intersecting lanes 122 and 124 are lanes in the same direction.

In the example shown in FIG. 2B, the subject vehicle 100 is about to turn left and enter (merge with) the intersecting lane 122. Also, when passing near the traveling lane 102, another vehicle 128 traveling in the intersecting lane 124 is about to change lanes from the intersecting lane 124 on the farther side to the intersecting lane 122 on the closer side when viewed from the subject vehicle 100. This kind of lane change, that is, a lane change of another vehicle from a farther lane to a closer lane when viewed from a subject vehicle is hereinafter referred to as “lane change LC”.

As illustrated in FIG. 2B, another vehicle (for example, another vehicle 128) performs the lane change LC with respect to an intersecting lane (for example, intersecting lane 122) into which the subject vehicle 100 is about to enter. According to the existing FCTA, there is a possibility that an attention calling about the approach of another vehicle that performs the lane change LC may not be in time or may not be possible.

### 2-2. Collision Avoidance Based on Prediction of Lane Change of Another Vehicle

In view of the issue described above, according to the present embodiment, the ECU 10 (processor 12) predicts whether or not another vehicle performs the lane change LC from a farther lane to a closer lane when viewed from the subject vehicle 1, based on other-vehicle traveling information VI. Then, the ECU 10 executes a “driver assistance process PR” in a mode according to the prediction.

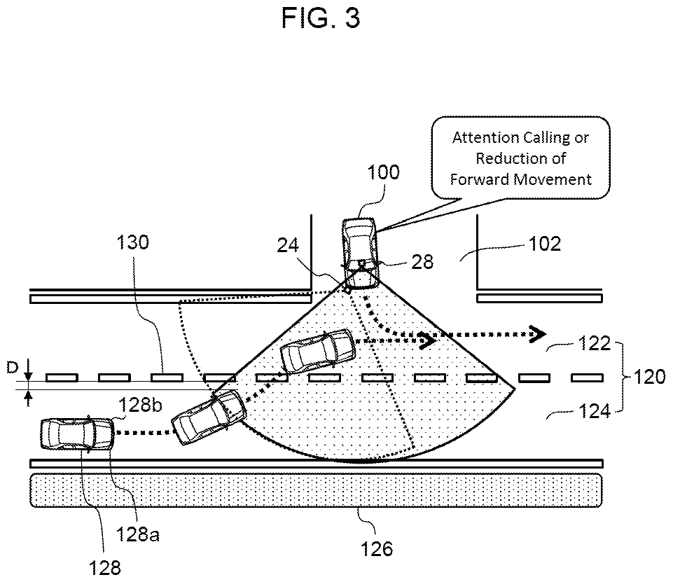

FIG. 3 is a diagram illustrating an example of a scene in which the driver assistance process PR is executed based on the prediction of the lane change LC of another vehicle according to the embodiment. As in FIG. 2B, FIG. 3 illustrates the another vehicle 128 that performs the lane change LC from the intersecting lane 124 on the farther side to the intersecting lane 122 on the closer side when viewed from the subject vehicle 1. It should be noted that FIG. 3 shows an angle of view (broken line) of the right front radar 24 and an angle of view (solid line) of the front camera 28.

The other-vehicle traveling information VI is related to traveling of the another vehicle 128 and is detected by the recognition sensor 20. The other-vehicle traveling information VI includes, for example, radar information and camera information. The recognition sensor 20 acquires the other-vehicle traveling information VI every designated time and supplies the other-vehicle traveling information VI to the ECU 10.

More specifically, the radar information is acquired using the right front radar 24 and the left front radar 26. The radar information includes, for example, a vehicle speed and a lateral speed of the another vehicle 128.

The camera information is acquired by analyzing an image captured by the front camera 28. The camera information includes, for example, information (blinker information) indicating whether or not a turn signal 128a or 128b of the another vehicle 128 is blinking. In addition, the camera information includes, for example, information (lane division line information) indicating a distance D of the another vehicle 128 with respect to a lane division line (in FIG. 3, a lane division line 130) closer to the subject vehicle 1 among lane division lines (for example, white lines) that define a traveling lane (in FIG. 3, the intersecting lane 124) of the another vehicle 128. Since the blinker information and the lane division line information cannot be acquired using the radars 22 to 26, they are acquired using, for example, the front camera 28. The camera information may include only one of the blinker information and the lane division line information.

In the present embodiment, the prediction of the lane change LC of another vehicle is performed using a machine learning model based on the other-vehicle traveling information VI. An example of the machine learning model is a hidden Markov model (HMM). According to the HMM, the result of the prediction can be acquired in the form of a probability (%) that another vehicle is predicted to perform the lane change LC. Hereinafter, the probability is referred to as a “lane change probability P”. The learning of the HMM is performed in advance by using data of various traffic scenes. The ECU 10 includes an HMM whose learning is completed in this way.

As described above, the HMM is configured to receive the other-vehicle traveling information VI as an input and output a lane change probability P. More specifically, the HMM outputs a lane change probability P according to the other-vehicle traveling information VI supplied from the recognition sensor 20 at designated time intervals. Therefore, when another vehicle present around the subject vehicle 1 within a range recognizable by the recognition sensor 20 actually starts to exhibit a behavior leading to the lane change LC (for example, another vehicle 128 in FIG. 3), the lane change probability P output from the HMM becomes high. On the other hand, for example, when another vehicle present around the subject vehicle 1 does not exhibit the behavior leading to the lane change LC, the lane change probability P becomes low. As just described, the lane change probability P for the same other vehicle may change with lapse of time.

In addition, with respect to the blinker information described above, the blinking of the turn signals (more specifically, a turn signal closer to the subject vehicle 1) 128a or 128b of the another vehicle 128 acts to increase the lane change probability P in the HMM. In the example shown in FIG. 3, the blinking of the turn signal 128b on the left side of the another vehicle 128 acts to increase the lane change probability P for the lane change LC to the left side. In other words, when the turn signal 128b is blinking, the HMM outputs a higher lane change probability P than when the turn signal 128b is not blinking.

In addition, shortening of the distance D in the lane division line information described above acts to increase the lane change probability P in the HMM. That is, when the distance D becomes shorter, the HMM outputs a higher lane change probability P than when the distance D becomes longer.

The driver assistance process PR is executed by the ECU 10 in order to avoid a collision between the subject vehicle 1 and the another vehicle 128. To be specific, the driver assistance process PR includes a first process PR1 and a second process PR2.

The first process PR1 is a process of controlling an actuator (i.e., an actuator included in at least one of the drive device 40 and the brake device 50) so as to reduce the forward movement of the subject vehicle 1. The “forward movement” referred to herein includes starting of the subject vehicle 1.

To be more specific, the first process PR1 includes, for example, automatically reducing the output of the actuator (e.g., internal combustion engine or electric motor) included in the drive device 40 in order to reduce the forward movement such as starting of the subject vehicle 1. In addition, the first process PR1 includes, for example, automatically braking the subject vehicle 1 by controlling the brake actuator included in the brake device 50 in order to reduce the forward movement such as starting of the subject vehicle 1.

The second process PR2 is a process of controlling the HMI device 30 so as to perform notification related to attention calling for collision avoidance between the subject vehicle 1 and the another vehicle 128. For example, the notification by the second process PR2 is related to attention calling using at least one of the buzzer and the speaker of the HMI device 30. In addition, the notification may be related to attention calling by the display of the HMI device 30. Alternatively, the notification may be related to both of these kinds of attention callings. More specifically, the attention callings are, for example, to urge reduction of the forward movement (including starting) of the subject vehicle 1.

The driver assistance process PR based on the result of the prediction of the lane change LC is executed as follows, for example. That is, when the lane change probability P is equal to or greater than a designated threshold value TH1, the ECU 10 executes the first process PR1. On the other hand, when the lane change probability P is less than the threshold value TH1, the ECU 10 executes the second process PR2.

Additionally, when the another vehicle that is the output target of the lane change probability P deviates from a range that can be recognized by the recognition sensor 20 of the subject vehicle 1 after the driver assistance process PR is started, the lane change probability P regarding the another vehicle cannot be obtained. As a result, the driver assistance process PR for the another vehicle ends.

Moreover, in the example shown in FIG. 3 described above, a scene in which the subject vehicle 1 is about to enter the “road 120 having two lanes on each side” that intersects with the traveling lane 102 of the subject vehicle 1 is illustrated. However, the prediction of the lane change LC according to the present embodiment may be performed for another vehicle traveling on a “road having three or more lanes on each side” that intersects with a traveling lane of a subject vehicle. For example, the prediction of the lane change probability P may be performed with respect to a lane change LC of another vehicle from an intersecting lane farthest from the subject vehicle 1 to an intersecting lane located at the center on a road having three lanes on each side. Further, even when a road intersecting with a traveling lane of a subject vehicle is a “road having one lane on each side”, another vehicle traveling on the road may perform a lane change LC to an opposite lane in order to pass a preceding vehicle. Therefore, the prediction of the lane change LC may be performed with respect to the lane change LC of another vehicle on this kind of road having one lane on each side. In addition, in the example shown in FIG. 3, a scene in which the subject vehicle 1 turns left in order to enter the road 120 intersecting with the traveling lane 102 of the subject vehicle 1 is illustrated. However, the driver assistance according to the present embodiment can also be applied to a scene in which a subject vehicle turns right to enter a road intersecting with a traveling lane of a subject vehicle on condition that the recognition sensor can recognize another vehicle.

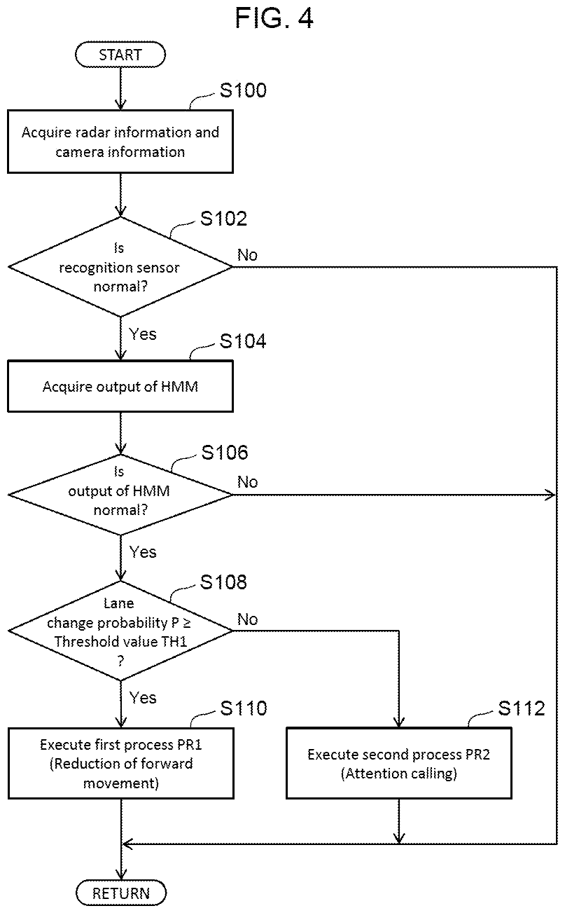

FIG. 4 is a flowchart related to the driver assistance process PR based on the prediction of the lane change LC of another vehicle according to the embodiment. The processing of this flowchart is repeatedly executed at designated time intervals when one or more designated operating conditions are satisfied. The one or more operating conditions include, for example, that the speed of the subject vehicle 1 is equal to or lower than a designated speed (for example, 15 km/h), that is, that a low vehicle speed condition is satisfied.

In step S100, the ECU 10 (processor 12) acquires the other-vehicle traveling information VI detected by the recognition sensor 20. As described above, the other-vehicle traveling information VI includes the radar information and the camera information.

Then, in step S102, the ECU 10 determines whether or not the output of the recognition sensor 20 is normal. As a result, when the recognition sensor 20 (more specifically, at least one of the radars 22 to 26 and the front camera 28) indicates an abnormal output, the processing proceeds to RETURN.

On the other hand, when the output of the recognition sensor 20 is normal in step S102, the ECU 10 acquires the output of the HMM in step S104. That is, the lane change probability P according to the other-vehicle traveling information VI acquired in step S100 is acquired.

Then, in step S106, the ECU 10 determines whether or not the output of the HMM is normal. To be specific, for example, when the value of the lane change probability P is a value determined in advance so as to be output when the output of the HMM is not normal, the determination result in step S106 becomes No. As a result, the processing proceeds to RETURN. In addition, when another vehicle is not present within the range recognizable by the recognition sensor 20, the other-vehicle traveling information VI of the another vehicle cannot be acquired. That is, the input information of the HMM is insufficient. Even in this kind of situation, the HMM cannot appropriately output a lane change probability P, and the determination result in step S106 therefore becomes No. As a result, the processing proceeds to RETURN.

On the other hand, when the output of the HMM is normal in step S106, the processing proceeds to step S108. In step S108, the ECU 10 determines whether or not the lane change probability P acquired in step S104 is equal to or greater than the threshold value TH1. The threshold value TH1 may be any value determined in advance, such as 50%, 60%, or 70%.

When the lane change probability P is equal to or greater than the threshold value TH1 in step S108, the ECU 10 executes the first process PR1 in step S110. As a result, in order to avoid a collision with another vehicle, the actuator included in at least one of the drive device 40 and the brake device 50 is controlled so as to reduce the forward movement (including starting) of the subject vehicle 1.

On the other hand, when the lane change probability P is less than the threshold value TH1 in step S108, the ECU 10 executes the second process PR2 in step S112. As a result, the HMI device 30 is controlled so as to notify the driver of the subject vehicle 1 about attention calling for avoiding a collision with another vehicle.

Additionally, when the determination result in step S108 is No, the ECU 10 may execute the following processing. That is, the ECU 10 may determine whether or not the lane change probability P is equal to or greater than a designated threshold value TH2. The threshold value TH2 is smaller than the threshold value TH1 and greater than 0%. The threshold value TH2 is, for example, a few percent or 20%. Then, when the lane change probability P is equal to or greater than the threshold value TH2 and less than the threshold value TH1 (TH2≤P<TH1), the ECU 10 may execute the processing of step S112. On the other hand, when the lane change probability P is less than the threshold value TH2 (P<TH2), the ECU 10 may execute a process of performing notification related to attention calling with a lower level of attention calling than that by the second process PR2 (step S112). For example, as this process, the ECU 10 may perform only display for calling attention using the display of the HMI device 30 without performing notification by sound or voice. Alternatively, for example, the ECU 10 may determine that the lane change probability P is sufficiently low and may not perform the attention calling itself.

### 3. Effect

As described above, according to the present embodiment, the ECU 10 predicts whether or not another vehicle performs a lane change LC based on the other-vehicle traveling information VI detected by the recognition sensor 20. This makes it possible to evaluate the risk of collision between the subject vehicle 1 and the another vehicle at an early stage. Then, the ECU 10 executes the driver assistance process PR in a mode according to the result of the prediction. As a result, when the subject vehicle 1 is about to enter a road having two or more lanes intersecting with the traveling lane of the subject vehicle 1, the driver assistance for collision avoidance can be appropriately performed with respect to the another vehicle about to perform the lane change LC to an intersecting lane closer to the subject vehicle 1.

More specifically, according to the present embodiment, the lane change probability P is used as the information indicating the result of the prediction. Then, the content of the driver assistance process PR is changed depending on whether or not the lane change probability P is equal to or greater than the threshold value TH1. That is, when the lane change probability P is less than the threshold value TH1, the second process PR2 is executed to control the HMI device 30 so as to perform notification related to attention calling for collision avoidance with another vehicle. On the other hand, when the lane change probability P is equal to or greater than the threshold value TH1, the first process PR1 is executed to control the actuator so as to reduce the forward movement of the subject vehicle 1. That is, for the reason that the lane change probability P is high, a process of avoiding a collision is executed more actively. As described above, according to the present embodiment, the driver assistance process PR can be performed in an appropriate mode in accordance with the level of the lane change probability P.

Moreover, according to the present embodiment, the other-vehicle traveling information VI (camera information) used for the prediction of the lane change LC of another vehicle includes the information (blinker information) indicating whether or not a turn signal of the another vehicle is blinking. Accordingly, the accuracy of the prediction of the lane change LC can be satisfactorily increased.

Furthermore, according to the present embodiment, the other-vehicle traveling information VI (camera information) includes the information (lane division line information) indicating the distance D of another vehicle with respect to the lane division line closer to a subject vehicle among the lane division lines that define the traveling lane of the another vehicle. Accordingly, the accuracy of the prediction of the lane change LC can be satisfactorily increased.

What is claimed is:

1. A driver assistance device, comprising:
a recognition sensor including a camera that captures an image of another vehicle on a road having two or more lanes intersecting with a traveling lane of a subject vehicle, and configured to recognize a situation around the subject vehicle; and
a processor configured to execute a driver assistance process of assisting collision avoidance between the subject vehicle and the another vehicle, wherein
the processor is configured to:
predict whether or not the another vehicle performs a lane change from a farther lane to a closer lane when viewed from the subject vehicle, based on other-vehicle traveling information which is traveling information of the another vehicle detected by the recognition sensor; and
execute the driver assistance process in a mode according to a result of the prediction.

2. The driver assistance device according to claim 1, wherein
the other-vehicle traveling information includes information indicating whether or not a turn signal of the another vehicle is blinking.

3. The driver assistance device according to claim 1, wherein
the other-vehicle traveling information includes information indicating a distance of the another vehicle to a lane division line closer to the subject vehicle among lane division lines that define a traveling lane of the another vehicle.

4. The driver assistance device according to claim 1, wherein
the subject vehicle includes one or more actuators configured to control at least one of driving and braking of the subject vehicle, and a human machine interface (HMI) device configured to perform notification to a driver of the subject vehicle,
the result of the prediction is a lane change probability that the another vehicle is predicted to perform the lane change,
the driver assistance process includes: a first process of controlling the one or more actuators to reduce forward movement of the subject vehicle; and a second process of controlling the HMI device to perform notification related to attention calling for the collision avoidance, and
the processor is configured to execute the first process when the lane change probability is equal to or greater than a threshold value, and execute the second process when the lane change probability is less than the threshold value.

5. The driver assistance device according to claim 1, wherein
in a low vehicle speed condition in which a speed of the subject vehicle is equal to or lower than a designated speed, the processor is configured to execute the prediction and execute the driver assistance process in the mode according to the result of the prediction.
